(19) United States
(12) Patent Application Publication
(10) Pub. No.: US 2005/0286727 A1
(43) Pub. Date: Dec. 29, 2005

(54) Apparatus for expanding sound image upward

(75) Inventor: Kazuhito Otsuka, Takasaki-shi (JP)

Correspondence Address: LOUIS WOO;LAW OFFICE OF LOUIS WOO, 717 NORTH FAYETTE STREET, ALEXANDRIA, VA, 22314, US

(73) Assignee: Victor Company of Japan, Ltd., Yokohama (JP)

(21) Appl. No.: 11/152,155

(22) Filed: Jun. 15, 2005

(30) Foreign Application Priority Data
Jun. 25, 2004 (JP) 2004-187246

(51) Int. Cl. H04R 5/00; H04R 1/40; H04R 5/02

(52) U.S. Cl. 381/18; 381/307; 381/97

(57) ABSTRACT

An apparatus for expanding a sound image upward includes a left-channel phase delay circuit for correcting phases and amplitudes of components of an input left-channel audio signal which are in a predetermined high-frequency range to generate a corrected left-channel audio signal. A right-channel phase delay circuit operates for correcting phases and amplitudes of components of an input right-channel audio signal which are in the predetermined high-frequency range to generate a corrected right-channel audio signal. A surround circuit operates for generating left-channel and right-channel surround audio signals in response to the corrected left-channel and right-channel audio signals generated by the left-channel phase delay circuit and the right-channel phase delay circuit.

### BACKGROUND OF THE INVENTION

1. Field of the Invention

This invention generally relates to a sound image locating circuit in a sound field reproducing system. This invention particularly relates to an audio correction circuit for expanding a sound image upward from original one corresponding to a loudspeaker.

2. Description of the Related Art

A typical loudspeaker has a directivity of sound emission which tends to depend on sound frequency. Generally, a desired position of the loudspeaker is directly in front of listener's ear. Usually, a human ear is sensitive to the direction from which high-frequency sound emanates. On the other hand, the human ear is insensitive to that concerning low-frequency sound.

When a box containing a loudspeaker is placed on a floor, listener's ear is usually in upper front of the loudspeaker. In this case, first portions of sound directly propagate from the loudspeaker to the listener's ear while second portions thereof reach the listener's ear after being reflected at the surface of the floor. The floor surface has a certain frequency-dependent reflectivity. Generally, upon the reflection at the floor surface, high-frequency sound is more absorbed than low-frequency sound is. In the case where the listener's ear is in upper front of the loudspeaker, the frequency-dependent reflectivity of the floor surface, the frequency-dependent directivity of the loudspeaker, and the frequency-dependent sensitivity of the listener's ear concerning the sound direction cause the listener to perceive weaker high-frequency sound generated by the loudspeaker than low-frequency sound.

Even in that case, properly emphasizing high-frequency components of an audio signal applied to the loudspeaker can substantially equalize the levels of high-frequency sound and low-frequency sound perceived by the listener. When the perceived levels of high-frequency sound and low-frequency sound are substantially equal, the listener feels that a sound source is directly in front of the listener's ear. Thus, in this case, the position of a virtual sound source perceived by the listener is moved upward from the actual position of the loudspeaker. Basically, this condition corresponds to upward expansion of a sound image perceived by the listener from its original state.

Japanese utility model application publication number 5-43700/1993 discloses a sound field controlling apparatus in which basic audio signals generated by an audio signal source are processed to generate effect sound signals including early reflected sound signals and reverberant sound signals. The effect sound signals are added to the basic audio signals to generate final audio signals fed to loudspeakers. The effect sound signals are designed to emphasize signal components in a specified frequency band which cause a listener to feel that sound sources are located above listener's head due to listener's hearing sense. The specified frequency band extends around 8 kHz. The apparatus of Japanese application 5-43700/1993 uses a digital signal processor for generating the effect sound signals. Generally, the use of the digital signal processor results in a low cost/performance ratio.

U.S. Pat. No. 5,850,453 relates to an acoustic correction apparatus which processes a pair of left and right input signals to compensate for spatial distortion as a function of frequency when the input signals are reproduced through speakers in a sound system. The sound energy of the left and right input signals is separated and corrected in a first low-frequency range and a second high-frequency range. The resultant signals are recombined to create image-corrected audio signals having a desired sound-pressure response when reproduced by the speakers in the sound system. The desired sound-pressure response creates an apparent sound image location with respect to a listener. The image-corrected signals may then be spatially enhanced to broaden the apparent sound image.

### SUMMARY OF THE INVENTION

It is an object of this invention to provide a simple apparatus for expanding a sound image upward.

A first aspect of this invention provides an apparatus for expanding a sound image upward. The apparatus comprises a left-channel phase delay circuit for correcting phases and amplitudes of components of an input left-channel audio signal which are in a predetermined high-frequency range to generate a corrected left-channel audio signal; a right-channel phase delay circuit for correcting phases and amplitudes of components of an input right-channel audio signal which are in the predetermined high-frequency range to generate a corrected right-channel audio signal; and a surround circuit for generating left-channel and right-channel surround audio signals in response to the corrected left-channel and right-channel audio signals generated by the left-channel phase delay circuit and the right-channel phase delay circuit. The surround circuit includes a summing circuit for adding the corrected left-channel and right-channel audio signals to generate an addition signal, a mid-frequency-range correction filter for filtering the addition signal to generate a filtered signal, a subtracter for subtracting one of the corrected left-channel and right-channel audio signals from the other to generate a first difference signal, a filter circuit for removing components from the first difference signal which are in the predetermined high-frequency range to generate a second difference signal, a phase delay device for delaying a phase of the second difference signal to generate a third difference signal, a first mixer for combining the corrected left-channel audio signal, the filtered signal, and the third difference signal to generate the left-channel surround audio signal, and a second mixer for combining the corrected right-channel audio signal, the filtered signal, and the third difference signal to generate the right-channel surround signal.

A second aspect of this invention is based on the first aspect thereof, and provides an apparatus wherein the left-channel phase delay circuit includes a first resistor; a second resistor; an operational amplifier having a first input terminal receiving the input left-channel audio signal via the first resistor, a second input terminal receiving the input left-channel audio signal via the second resistor, and an output terminal followed by the surround circuit; a third resistor connected between the second input terminal and the output terminal of the operational amplifier; and a capacitor having a first end connected to a junction between the first resistor and the first input terminal of the operational amplifier and a second end grounded.

A third aspect of this invention is based on the second aspect thereof, and provides an apparatus wherein values of the first and third resistors are substantially equal, and a value of the second resistor is smaller than each of the values of the first and third resistors.

A fourth aspect of this invention is based on the second aspect thereof, and provides an apparatus further comprising a switch interposed between the capacitor and a ground.

A fifth aspect of this invention is based on the first aspect thereof, and provides an apparatus wherein the right-channel phase delay circuit includes a first resistor; a second resistor; an operational amplifier having a first input terminal receiving the input right-channel audio signal via the first resistor, a second input terminal receiving the input right-channel audio signal via the second resistor, and an output terminal followed by the surround circuit; a third resistor connected between the second input terminal and the output terminal of the operational amplifier; and a capacitor having a first end connected to a junction between the first resistor and the first input terminal of the operational amplifier and a second end grounded.

A sixth aspect of this invention is based on the fifth aspect thereof, and provides an apparatus wherein values of the first and third resistors are substantially equal, and a value of the second resistor is smaller than each of the values of the first and third resistors.

A seventh aspect of this invention is based on the fifth aspect thereof, and provides an apparatus further comprising a switch interposed between the capacitor and a ground.

An eighth aspect of this invention provides an apparatus for expanding a sound image upward. The apparatus comprises a first left-channel phase delay circuit for correcting phases and amplitudes of components of an input left-channel audio signal which are in a predetermined high-frequency range to generate a first corrected left-channel audio signal; a second left-channel phase delay circuit for correcting phases and amplitudes of components of the first corrected left-channel audio signal which are in the predetermined high-frequency range to generate a second corrected left-channel audio signal; a first right-channel phase delay circuit for correcting phases and amplitudes of components of an input right-channel audio signal which are in the predetermined high-frequency range to generate a first corrected right-channel audio signal; a second right-channel phase delay circuit for correcting phases and amplitudes of components of the first corrected right-channel audio signal which are in the predetermined high-frequency range to generate a second corrected right-channel audio signal; and a surround circuit for generating left-channel and right-channel surround audio signals in response to the second corrected left-channel and right-channel audio signals generated by the second left-channel phase delay circuit and the second right-channel phase delay circuit. The surround circuit includes a summing circuit for adding the second corrected left-channel and right-channel audio signals to generate an addition signal, a mid-frequency-range correction filter of filtering the addition signal to generate a filtered signal, a subtracter for subtracting one of the second corrected left-channel and right-channel audio signals from the other to generate a first difference signal, a filter circuit for removing components from the first difference signal which are in the predetermined high-frequency range to generate a second difference signal, a phase delay device for delaying a phase of the second difference signal to generate a third difference signal, a first mixer for combining the second corrected left-channel audio signal, the filtered signal, and the third difference signal to generate the left-channel surround audio signal, and a second mixer for combining the second corrected right-channel audio signal, the filtered signal, and the third difference signal to generate the right-channel surround signal.

A ninth aspect of this invention provides an apparatus for expanding a sound image upward. The apparatus comprises a first resistor; a second resistor; an operational amplifier having a first input terminal receiving an input audio signal via the first resistor, a second input terminal receiving the input audio signal via the second resistor, and an output terminal; a third resistor connected between the second input terminal and the output terminal of the operational amplifier; a capacitor having a first end connected to a junction between the first resistor and the first input terminal of the operational amplifier and a second end grounded; and a surround circuit connected to the output terminal of the operational amplifier.

A tenth aspect of this invention is based on the ninth aspect thereof, and provides an apparatus wherein values of the first and third resistors are substantially equal, and a value of the second resistor is smaller than each of the values of the first and third resistors.

An eleventh aspect of this invention is based on the ninth aspect thereof, and provides an apparatus further comprising a switch interposed between the capacitor and a ground.

### BRIEF DESCRIPTION OF THE DRAWINGS

FIG. 1 is a schematic diagram of a prior-art surround circuit.

FIG. 2 is a schematic diagram of a phase delay circuit used as a portion of a sound-image upward expanding apparatus according to a first embodiment of this invention.

FIG. 3 is a diagram of the impedance-frequency characteristic and the phase-frequency characteristic of a typical loudspeaker.

FIG. 4 is a schematic diagram of the sound-image upward expanding apparatus in the first embodiment of this invention.

FIG. 5 is a diagram of the amplitude-frequency characteristic and the phase-frequency characteristic of the sound-image upward expanding apparatus of FIG. 4, and those of the prior-art surround circuit of FIG. 1.

FIG. 6 is a diagram of the amplitude-frequency characteristic and the phase-frequency characteristic of a sound reproducing system including a combination of the sound-image upward expanding apparatus of FIG. 4, a power amplifier, and a loudspeaker in a box which are measured when the apparatus of FIG. 4 is in either an effective state or an ineffective state.

FIG. 7 is a block diagram of a sound-image upward expanding apparatus according to a second embodiment of this invention.

FIG. 8 is a schematic diagram of a sound-image upward expanding apparatus according to a third embodiment of this invention.

FIG. 9 is a diagram of the amplitude-frequency characteristic and the phase-frequency characteristic of a typical loudspeaker.

FIG. 10 is a diagram of the amplitude-frequency characteristic and the phase-frequency characteristic of an ideal loudspeaker.

FIG. 11 is a diagram of an original loudspeaker, a sound-source area concerning the original loudspeaker, a virtual corrected loudspeaker, and a sound-source area concerning the virtual corrected loudspeaker.

FIG. 12 is a diagram of the original loudspeaker in FIG. 11, an original sound-source reproduction area, and an expanded sound-source reproduction area.

FIG. 13 is a diagram of an original loudspeaker in a box on a floor, a sound-source area concerning the original loudspeaker, a virtual corrected loudspeaker, and a sound-source area concerning the virtual corrected loudspeaker.

FIG. 14 is a diagram of the original loudspeaker in FIG. 13, an original sound-source reproduction area, and an expanded sound-source reproduction area.

FIG. 15 is a diagram of sound-source centers and sound-source reproduction areas of left and right channels.

FIG. 16 is a diagram of a dummy head, original sound sources of left and right channels, and virtual sound sources of left and right channels.

FIG. 17 is a diagram of the amplitude-frequency characteristic of a sound reproducing system including a combination of the sound-image upward expanding apparatus of FIG. 4, a power amplifier, and left-channel and right-channel loudspeakers in boxes which are measured under first predetermined conditions when the apparatus of FIG. 4 is in either the effective state or the ineffective state.

FIG. 18 is a diagram of the amplitude-frequency characteristic of a sound reproducing system including a combination of the sound-image upward expanding apparatus of FIG. 4, a power amplifier, and left-channel and right-channel loudspeakers in boxes which are measured under second predetermined conditions when the apparatus of FIG. 4 is in either the effective state or the ineffective state.

### DETAILED DESCRIPTION OF THE INVENTION

Prior-art apparatuses will be explained below for a better understanding of this invention.

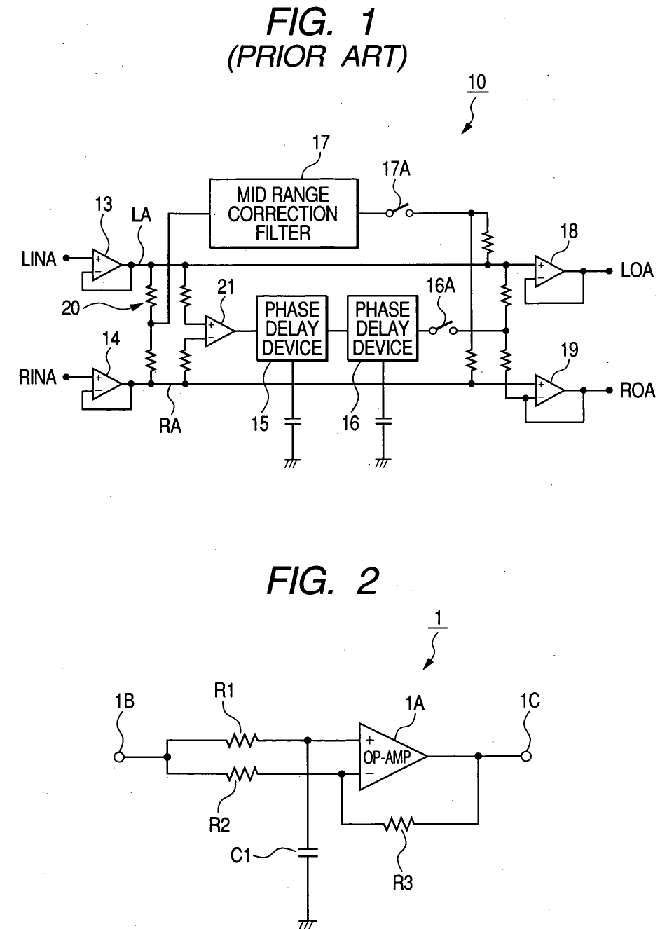

FIG. 1 shows a prior-art surround circuit 10 which includes buffer amplifiers 13 and 14 for left and right channels respectively. The buffer amplifiers 13 and 14 receive first audio signals LINA and RINA of the left and right channels respectively, and output second audio signals LA and RA of the left and right channels respectively.

The prior-art surround circuit 10 in FIG. 1 further includes phase delay devices 15 and 16, a mid-frequency-range correction filter 17, and mixers 18 and 19. The second left-channel audio signal LA is inputted into the mixer 18 from the buffer amplifier 13. The second right-channel audio signal RA is inputted into the mixer 19 from the buffer amplifier 14.

The buffer amplifier 13 and 14 are followed by a summing device 20 including a combination of resistors. The summing device 20 adds the second left-channel and right-channel audio signals LA and RA to generate a sum audio signal LA+RA. The mid-frequency-range correction filter 17 receives the sum audio signal LA+RA, and corrects mid-frequency components thereof. The mid-frequency-range correction filter 17 outputs the correction-resultant audio signal to the mixers 18 and 19 when a switch 17A following the filter 17 is closed.

The buffer amplifiers 13 and 14 are also followed by a subtracter 21. The device 21 subtracts the second right-channel audio signal RA from the second left-channel audio signal LA to generate a subtraction audio signal LA−RA. The device 21 may subtract the second left-channel audio signal LA from the second right-channel audio signal RA to generate a subtraction audio signal RA−LA. The subtraction audio signal LA−RA is passed successively through the phase delay devices 15 and 16 while being delayed. Provided that a switch 16A following the phase delay device 16 is closed, the delayed subtraction audio signal LA−RA propagates from the phase delay device 16 to the mixers 18 and 19.

The mixer 18 combines the second left-channel audio signal LA, the correction-resultant audio signal, and the delayed subtraction audio signal LA−RA to form a left-channel surround audio signal LoA. The mixer 18 outputs the left-channel surround audio signal LoA. The mixer 19 combines the second right-channel audio signal RA, the correction-resultant audio signal, and the delayed subtraction audio signal LA−RA to form a right-channel surround audio signal RoA. The mixer 19 outputs the right-channel surround audio signal RoA.

A prior-art apparatus for expanding a sound image upward includes a combination of a graphic equalizer circuit and the prior-art surround circuit 10 in FIG. 1. The prior-art apparatus implements complicated signal processing which tends to cause a distortion of reproduced sound and a reduction in the signal/noise ratio thereof.

### Concept of the Invention

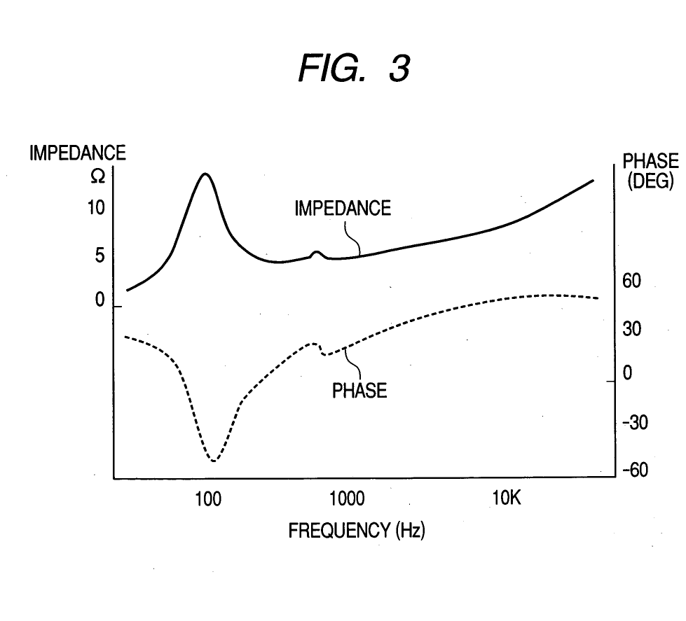

FIG. 3 shows the impedance-frequency characteristic and the phase-frequency characteristic of a typical loudspeaker. With reference to FIG. 3, in a high-frequency range, the impedance of the loudspeaker increases as the frequency of an audio signal inputted thereto rises. The increase in the impedance causes a drop in the pressure of sound reproduced by the loudspeaker. Furthermore, in the high-frequency range, the phase of sound reproduced by the loudspeaker advances as the frequency of the input audio signal rises.

The concept of this invention will be described below. As shown in FIG. 9, a typical full-range loudspeaker has a relatively small upper limit of the frequency of reproducible sound. In a high-frequency range, the amplitude of sound reproduced by the typical full-range loudspeaker decreases as the frequency of sound rises. In mid-frequency and high-frequency ranges, the phase of sound reproduced by the typical full-range loudspeaker advances as the sound frequency rises.

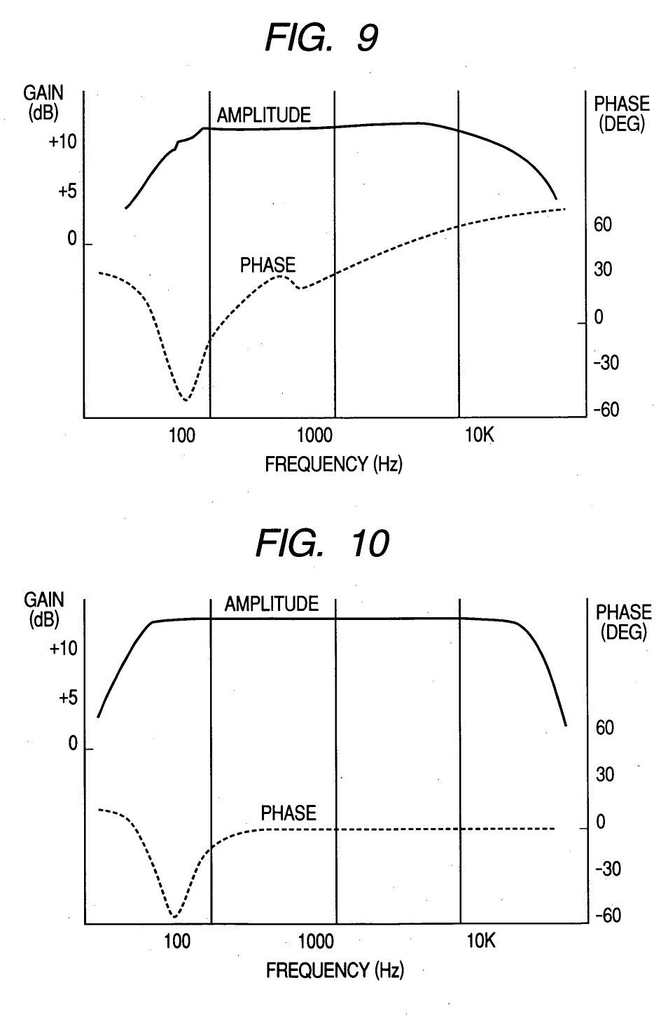

As shown in FIG. 10, the amplitude of sound reproduced by an ideal loudspeaker is flat over a wide audio frequency range including low-frequency, mid-frequency, and high-frequency ranges. The phase of sound reproduced by the ideal loudspeaker is constant in mid-frequency and high-frequency ranges.

This invention simultaneously corrects the amplitude and phase of an audio signal inputted to an actual loudspeaker through signal processing to implement loudspeaker characteristic conversion, thereby apparently providing frequency characteristics (a frequency response) equivalent to those of the ideal loudspeaker. Specifically, this invention raises the loudspeaker-related upper limit of the frequency of reproducible sound, and flattens the phase of reproduced sound in mid-frequency and high-frequency ranges. Thereby, this invention improves the quality of sound reproduced by an actual loudspeaker, and expands a sound source and a sound image perceived by a listener.

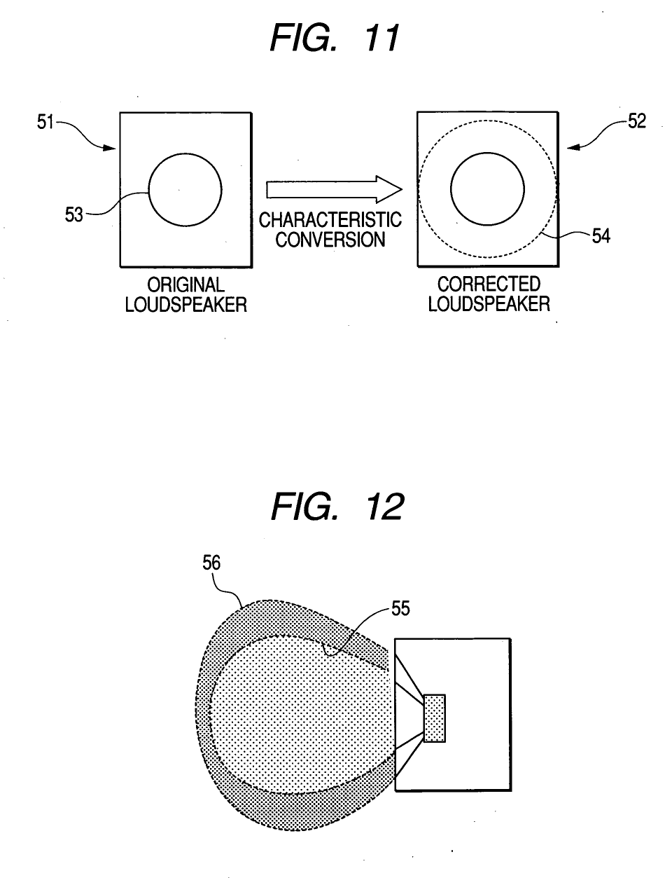

With reference to FIG. 11, this invention apparently converts the characteristics of an original loudspeaker (an original full-range loudspeaker) 51 to virtually form a corrected loudspeaker 52. As a result of the loudspeaker characteristic conversion, the sound-source area 54 corresponding to the corrected loudspeaker 52 is expanded from the sound-source area 53 concerning the original loudspeaker 51. As shown in FIG. 12, the spatial sound-source reproduction area 56 provided by the corrected loudspeaker 52 is expanded from the spatial sound-source reproduction area 55 concerning the original loudspeaker 51.

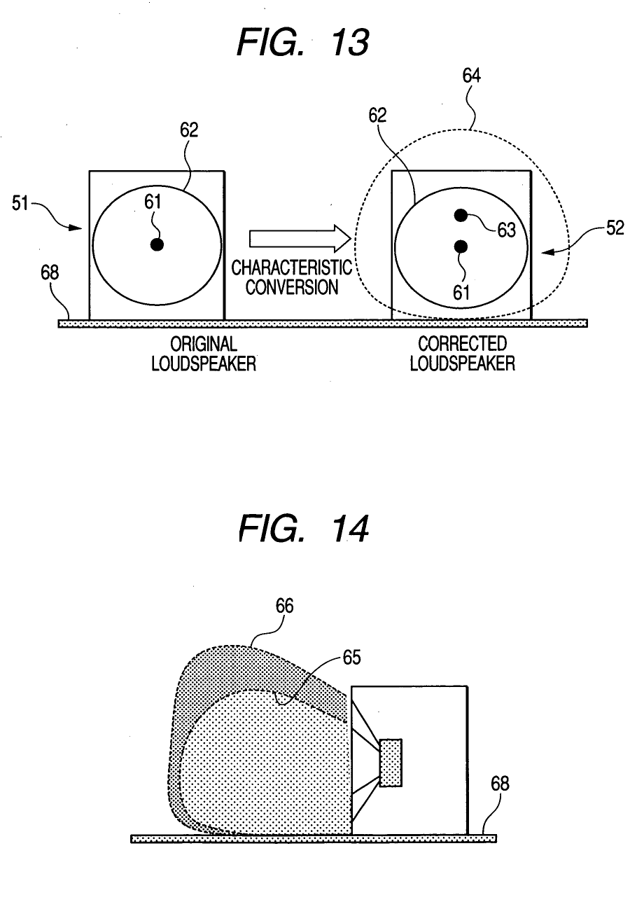

In the case where a box containing the original loudspeaker 51 is placed on a floor 68, a sound-source center 61 and a sound-source reproduction area 62 are defined with respect to the original loudspeaker 51 as shown in FIG. 13. In this case, a portion of sound emitted from the original loudspeaker 51 is reflected at the surface of the floor 68 before reaching the listener. The presence of the floor 68 and the reflection of sound cause a sound-source reproduction area 64 concerning the corrected loudspeaker 52 to expand in directions except downward ones as shown in FIG. 13. In addition, a sound-source center 63 concerning the corrected loudspeaker 52 is located above the sound-source center 61 of the original loudspeaker 51. As shown in FIG. 14, the spatial sound-source reproduction area 66 provided by the corrected loudspeaker 52 is expanded upward from the spatial sound-source reproduction area 65 concerning the original loudspeaker 51.

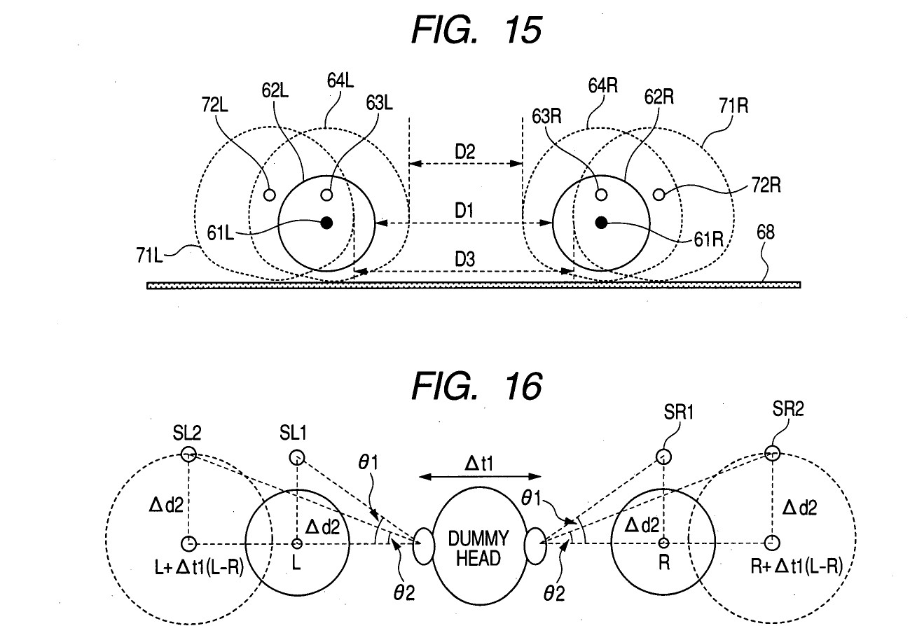

As shown in FIG. 15, sound-source centers 61L and 61R and sound-source reproduction areas 62L and 62R are defined with respect to original left-channel and right-channel loudspeakers spaced at a certain interval. The distance between the sound-source reproduction areas 62L and 62R is denoted by D1. This invention apparently converts the characteristics of the original left-channel and right-channel loudspeakers to virtually form corrected left-channel and right-channel loudspeakers. As a result of the loudspeaker characteristic conversion, a sound-source reproduction area 64L corresponding to the corrected left-channel loudspeaker is expanded from the sound-source reproduction area 62L concerning the original left-channel loudspeaker. In addition, a sound-source reproduction area 64R corresponding to the corrected right-channel loudspeaker is expanded from the sound-source reproduction area 62R concerning the original right-channel loudspeaker. Furthermore, sound-source centers 63L and 63R concerning the corrected left-channel and right-channel loudspeakers are located above the sound-source centers 61L and 61R of the original left-channel and right-channel loudspeakers respectively. The distance D2 between the sound-source reproduction areas 64L and 64R concerning the corrected left-channel and right-channel loudspeakers is shorter than the distance D1 between the sound-source reproduction areas 62L and 62R corresponding to the original left-channel and right-channel loudspeakers.

This invention combines surround signal processing with the loudspeaker characteristic conversion. With reference to FIG. 15, the combination of the loudspeaker characteristic conversion and the surround signal processing provides sound-source reproduction areas 71L and 71R which are shifted outward from the sound-source reproduction areas 64L and 64R corresponding to the corrected left-channel and right-channel loudspeakers respectively. In addition, the combination of the loudspeaker characteristic conversion and the surround signal processing causes sound-source centers 72L and 72R moved outward from the sound-source centers 63L and 63R concerning the corrected left-channel and right-channel loudspeakers respectively. The distance D3 between the sound-source reproduction areas 71 L and 71 R resulting from the surround signal processing is longer than the distance D1 between the sound-source reproduction areas 62L and 62R corresponding to the original left-channel and right-channel loudspeakers. Accordingly, the surround signal processing enhances the performance of stereophony.

With reference to FIG. 16, there is a dummy head for listener's head. There is a stereophonic sound source for original left-channel sound L and original right-channel sound R. Left-channel and right-channel surround signals are expressed as L+Δt1(L−R) and R+Δt1(L−R) respectively, where Δt1 denotes the time difference between the ears of the dummy head. The loudspeaker characteristic conversion provides first virtual sound sources SLl and SR1 moved upward from the original left-channel and right-channel sound sources respectively. For the upward sound-source movement distance Δd2, there occurs a phase angle Θ1 concerning the first virtual sound sources SL1 and SR1. The combination of the loudspeaker characteristic conversion and the surround signal processing provides second virtual sound sources SL2 and SR2 moved outward from the first virtual sound sources SL1 and SR1 respectively. There occurs a phase angle Θ2 concerning the second virtual sound sources SL2 and SR2. The phase angle Θ1 concerning the first virtual sound sources SL1 and SR 1, the phase angle Θ2 concerning the second virtual sound sources SL2 and SR2, the upward sound-source movement distance Δd2, and other parameters are in the following relations.
Tan Θ1=Δd2/L
Tan Θ2=Δd2/{L+Δt1(L−R)}
TanΘ1=Δd2/R
Tan Θ2=Δd2/{R+Δt1(L−R)}
Tan Θ1>Tan Θ2{∵L+Δt1(L−R)>L}

Thus, the phase angle Θ2 is always smaller than the phase angle Θ1 when the surround signal processing causes outward movements of the left-channel and right-channel sound sources perceived by the listener. Therefore, the combination of the loudspeaker characteristic conversion and the surround signal processing suppresses ear reflection interference with reproduced sound perceived by the listener, thereby making the reproduced sound natural. The surround signal processing allows upward expansion of a sound image perceived by the listener with a smaller phase shift. For example, when the length L+Δt1(L−R) is 30 cm and the phase angle Θ2 is 20°, the upward sound-source movement distance Δd2 is 10.9 cm.

### First Embodiment

FIG. 2 shows a phase delay circuit 1 used as a portion of an apparatus for expanding a sound image upward according to a first embodiment of this invention.

As shown in FIG. 2, the phase delay circuit 1 includes an operational amplifier 1A, resistors R1, R2, and R3, and a capacitor C1. A circuit input terminal 1B is connected via the resistor R1 to the non-inverting input terminal of the operational amplifier 1A. The circuit input terminal 1B is also connected via the resistor R2 to the inverting input terminal of the operational amplifier 1A. The non-inverting input terminal of the operation amplifier 1A is grounded via the capacitor C1. The resistor R3 is connected between the inverting input terminal of the operational amplifier 1A and the output terminal thereof. The resistor R3 serves as a feedback element. The output terminal of the operational amplifier 1A leads to a circuit output terminal 1C.

An input audio signal is applied to the phase delay circuit 1 via the circuit input terminal 1B. The phase delay circuit 1 processes the input audio signal into an output audio signal which is fed via the circuit output terminal 1C to an external device. The operational amplifier 1A in the phase delay circuit 1 serves as an inverter. The capacitor C1 and the resistor R1 in the phase delay circuit 1 compose a filter connected with the inverter. The phase delay circuit 1 subjects the input audio signal to frequency-dependent phase shift and frequency-dependent gain adjustment.

The designing of the phase delay circuit 1 has a basic aspect and an advanced aspect. The basic aspect of the designing is intended to compensate for the above-indicated sound pressure drop and phase advance in the high-frequency range which are caused by the characteristics of the loudspeaker. The advanced aspect of the designing is intended to compensate for a drop in pressure of reproduced high-frequency sound perceived by a listener when listener's ear is in upper front of a loudspeaker or in upper right or left front thereof.

According to the basic aspect of the designing of the phase delay circuit 1, the values of the resistors R1, R2, and R3, and the capacitor C1 are chosen to provide a desired frequency-dependent phase shift and a desired frequency-dependent gain corresponding to a desired compensation performance for a loudspeaker in a sound reproducing system. The phase delay circuit 1 can vary the signal phase in the range from 0 to −180° depending on the values of the resistor R1 and the capacitor C1.

Preferably, the values of the resistors R1 and R3 are equal, and the value of the resistor R2 is smaller than that of each of the resistors R1 and R3. In this case, in a frequency range below a specific frequency Fc equal to 1/(2πC1·R1), the transfer function G of the phase delay circuit 1 is expressed as follows.
G=(1−jωC1·R1)/(1+jωC1·R1)
where “ω” denotes an angular frequency and R1 denotes the value of the resistor R1, and C1 denotes the value (capacitance) of the capacitor C1. On the other hand, in a frequency range above the specific frequency Fc, the transfer function G of the phase delay circuit 1 is expressed as follows.
G={R3(1+jωC1·R1)−R2}/{R2(1+jωC1•R1)}
where R2 denotes the value of the resistor R2, and R3 denotes the value of the resistor R3. Thus, in the frequency range below the specific frequency Fc, the phase delay circuit 1 serves as an all-pass filter with a gain fixed to 1. A phase variation is absent from the frequency range below the specific frequency Fc. The amplitude characteristic of the phase delay circuit 1 changes at the specific frequency Fc. In the frequency range above the specific frequency Fc, the phase delay circuit 1 has a frequency-dependent gain and provides a frequency-dependent phase delay of 0 to −180° also depending on the values of the resistor R1 and the capacitor C1.

Thus, when the values of the resistors R1 and R3 are equal and the value of the resistor R2 is smaller than that of each of the resistors R1 and R3, the phase delay circuit 1 has a specific frequency Fc (=1/(2πC1·R1)). In this case, the gain of the phase delay circuit 1 remains fixed to 1 and the signal phase is constant as the frequency rises to the specific frequency Fc. On the other hand, in a frequency range above the specific frequency Fc, the capacitor C1 exhibits a smaller impedance so that the phase delay circuit 1 serves as an inverting amplifier having a frequency-dependent gain greater than 1 and providing a frequency-dependent phase delay. Therefore, the phase delay circuit 1 can compensate for a pressure drop and a phase advance of sound reproduced by a loudspeaker in a high-frequency range.

The sound-image upward expanding apparatus in the first embodiment of this invention is used in a sound reproducing system including a pair of left-channel and right-channel loudspeakers.

As previously mentioned, each of the loudspeakers has a directivity of sound emission which tends to depend on sound frequency. Generally, a desired position of the loudspeaker is directly in front of listener's ear. Usually, a human ear is sensitive to the direction from which high-frequency sound emanates. On the other hand, the human ear is insensitive to that concerning low-frequency sound. When a box containing a loudspeaker is placed on a floor, listener's ear is usually in upper front of the loudspeaker. In this case, first portions of sound directly propagate from the loudspeaker in the box to the listener's ear while second portions thereof reach the listener's ear after being reflected at the surface of the floor. The floor surface has a certain frequency-dependent reflectivity. Generally, upon the reflection at the floor surface, high-frequency sound is more absorbed than low-frequency sound is. In the case where the listener's ear is in upper front of the loudspeaker, the frequency-dependent reflectivity of the floor surface, the frequency-dependent directivity of the loudspeaker, and the frequency-dependent sensitivity of the listener's ear concerning the sound direction cause the listener to perceive weaker high-frequency sound generated by the loudspeaker than low-frequency sound. Even in this case, properly emphasizing high-frequency components of an audio signal applied to the loudspeaker can substantially equalize the levels of high-frequency sound and low-frequency sound perceived by the listener. When the perceived levels of high-frequency sound and low-frequency sound are substantially equal, the listener feels that a sound source is directly in front of the listener's ear. Thus, in this case, the position of a virtual sound source perceived by the listener is moved upward from the actual position of the loudspeaker. Basically, this condition corresponds to upward expansion of a sound image perceived by the listener from its original state. The previously-indicated advanced aspect of the designing of the phase delay circuit 1 is intended to compensate for the drop in the pressure of high-frequency sound perceived by the listener when the listener's ear is in upper front of the loudspeaker or in upper left or right front thereof.

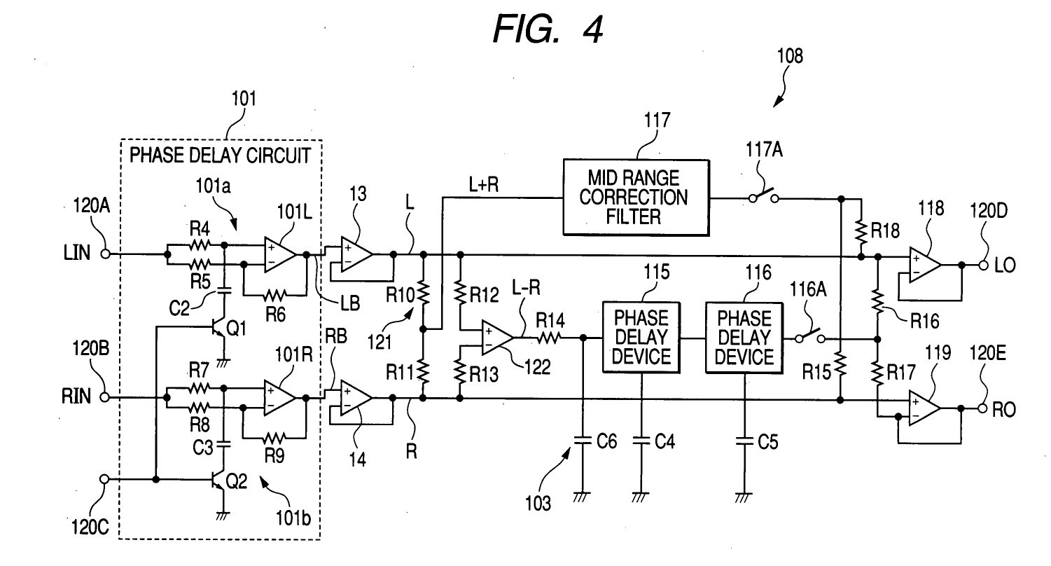

FIG. 4 shows the sound-image upward expanding apparatus in the first embodiment of this invention. The apparatus of FIG. 4 includes a phase delay circuit 101 and a surround circuit 108 following the phase delay circuit 101.

The apparatus of FIG. 4 receives first left-channel and right-channel audio signals LIN and RIN from an audio signal source (not shown) via apparatus input terminals 120A and 120B respectively. The apparatus of FIG. 4 processes the first left-channel and right-channel audio signals LIN and RIN into left-channel and right-channel surround audio signals Lo and Ro. The left-channel and right-channel surround audio signals Lo and Ro are outputted from the apparatus of FIG. 4 to an external device via apparatus output terminals 120D and 120E respectively. The external device includes a power amplifier connected to the left-channel and right-channel loudspeakers.

The phase delay circuit 101 receives the first left-channel and right-channel audio signals LIN and RIN. Normally, for a low-frequency range, the phase delay circuit 101 serves as an all-pass filter with a gain fixed to 1. Normally, the phase delay circuit 101 subjects high-frequency components of the first left-channel and right-channel audio signals LIN and RIN to phase shift and amplitude emphasis which compensate for phase variation and pressure reduction of loudspeaker-reproduced high-frequency sounds perceived by a listener. The high-frequency components mean components in a predetermined high-frequency range. As a result of the compensation by the phase delay circuit 101, it is possible to expand a sound image upward. The phase delay circuit 101 processes the first left-channel and right-channel audio signals LIN and RIN into second left-channel and right-channel audio signals LB and RB respectively.

The phase delay circuit 101 has a left-channel section 10la and a right-channel section 101b. The left-channel section 10la includes an operational amplifier 101L, resistors R4, R5, and R6, a capacitor C2, and a transistor Q1. The apparatus input terminal 120A is connected via the resistor R4 to the non-inverting input terminal of the operational amplifier 101L. The apparatus input terminal 120A is also connected via the resistor R5 to the inverting input terminal of the operational amplifier 101L. The non-inverting input terminal of the operation amplifier 101L is connected via the capacitor C2 to the collector of the transistor Q1. The base of the transistor Q1 is connected to an apparatus input terminal 120C. The emitter of the transistor Q1 is grounded. The resistor R6 is connected between the inverting input terminal of the operational amplifier 101L and the output terminal thereof. The resistor R6 serves as a feedback element. The output terminal of the operational amplifier 101L leads to the surround circuit 108.

Preferably, the values of the resistors R4 and R6 are exactly or approximately equal, and the value of the resistor R5 is smaller than that of each of the resistors R4 and R6. According to a first example, the values of the resistors R4, R5, and R6 are 22 kΩ, 10 kΩ, and 22 kΩ respectively, and the value of the capacitor C2 is 0.0033 μF. According to a second example, the values of the resistors R4, R5, and R6 are 10 kΩ,4.7 kΩ, and 10 kΩ respectively, and the value of the capacitor C2 is 0.0047 μF. According to a third example, the values of the resistors R4, R5, and R6 are 10 kΩ, 4.7 kΩ, and 10 kΩ respectively, and the value of the capacitor C2 is 0.0068 μF.

The left-channel section 101a in the phase delay circuit 101 receives the first left-channel audio signal LIN. The left-channel section 101a processes the first left-channel audio signal LIN into the second left-channel audio signal LB which appears at the output terminal of the operational amplifier 101L. The transistor Q1 serves as a switch for selectively connecting and disconnecting the capacitor C2 to and from the ground. Specifically, the base of the transistor Q1 receives a control signal via the apparatus input terminal 120C. When the control signal assumes a high-level state, the emitter-collector path of the transistor Q1 becomes conductive so that the capacitor C2 is connected to the ground and hence the left-channel section 101a falls into an active state. In this case, the left-channel section 101a subjects high-frequency components of the first left-channel audio signal LIN to phase shift and amplitude emphasis, and therefore the first left-channel audio signal LIN is corrected into the second left-channel audio signal LB. On the other hand, when the control signal assumes a low-level state, the emitter-collector path of the transistor Q1 becomes nonconductive so that the capacitor C2 is disconnected from the ground and hence the left-channel section 101a falls into an inactive state. In this case, the left-channel section 101a serves as a non-filtering buffer amplifier so that the second left-channel audio signal LB is substantially the same as the first left-channel audio signal LIN.

The right-channel section 101b of the phase delay circuit 101 includes an operational amplifier 101R, resistors R7, R8, and R9, a capacitor C3, and a transistor Q2. The apparatus input terminal 120B is connected via the resistor R7 to the non-inverting input terminal of the operational amplifier l0lR. The apparatus input terminal 120B is also connected via the resistor R8 to the inverting input terminal of the operational amplifier l0lR. The non-inverting input terminal of the operation amplifier 101R is connected via the capacitor C3 to the collector of the transistor Q2. The base of the transistor Q2 is connected to the apparatus input terminal 120C. The emitter of the transistor Q2 is grounded. The resistor R9 is connected between the inverting input terminal of the operational amplifier 101 R and the output terminal thereof. The resistor R9 serves as a feedback element. The output terminal of the operational amplifier 101R leads to the surround circuit 108.

Preferably, the values of the resistors R7 and R9 are exactly or approximately equal, and the value of the resistor R8 is smaller than that of each of the resistors R7 and R9. According to a first example, the values of the resistors R7, R8, and R9 are 22 kΩ, 10 kΩ, and 22 kΩ respectively, and the value of the capacitor C3 is 0.0033 μF. According to a second example, the values of the resistors R7, R8, and R9 are 10 kΩ, 4.7 kΩ, and 10 kΩ respectively, and the value of the capacitor C3 is 0.0047 μF. According to a third example, the values of the resistors R7, R8, and R9 are 10 kΩ, 4.7 kΩ, and 10 kΩ respectively, and the value of the capacitor C3 is 0.0068 μF.

The right-channel section 101 b of the phase delay circuit 101 receives the first right-channel audio signal RIN. The right-channel section 101b processes the first right-channel audio signal RIN into the second right-channel audio signal RB which appears at the output terminal of the operational amplifier 101 R. The transistor Q2 serves as a switch for selectively connecting and disconnecting the capacitor C3 to and from the ground. Specifically, the base of the transistor Q2 receives the control signal via the apparatus input terminal 120C. When the control signal assumes its high-level state, the emitter-collector path of the transistor Q2 becomes conductive so that the capacitor C3 is connected to the ground and hence the right-channel section 101b falls into an active state. In this case, the right-channel section 101b subjects high-frequency components of the first right-channel audio signal RIN to phase shift and amplitude emphasis, and therefore the first right-channel audio signal RIN is corrected into the second right-channel audio signal RB. On the other hand, when the control signal assumes its low-level state, the emitter-collector path of the transistor Q2 becomes nonconductive so that the capacitor C3 is disconnected from the ground and hence the right-channel section 101b falls into an inactive state. In this case, the right-channel section 101b serves as a non-filtering buffer amplifier so that the second right-channel audio signal RB is substantially the same as the first right-channel audio signal RIN.

The surround circuit 108 includes buffer amplifiers 113 and 114 for left and right channels respectively. The buffer amplifiers 113 and 114 receive the second left-channel and right-channel audio signals LB and RB from the phase delay circuit 101 respectively, and output third left-channel and right-channel audio signals L and R respectively. The second left-channel and right-channel audio signals LB and RB propagate through the buffer amplifiers 113 and 114 without being processed. Thus, the third left-channel and right-channel audio signals L and R are equal to the second left-channel and right-channel audio signals LB and RB respectively.

The surround circuit 108 further includes a CR filter 103, phase delay devices 115 and 116, a switch 116A, a mid-frequency-range correction filter 117, a switch 117A, mixers 118 and 119, a summing device 121, and a subtracter 122.

Each of the mixers 118 and 119 includes an operational amplifier. The non-inverting input terminal of the mixer 118 is directly connected to the output terminal of the buffer amplifier 113. The non-inverting input terminal of the mixer 119 is directly connected to the output terminal of the buffer amplifier 114. The summing device 121 follows the buffer amplifiers 113 and 114. The summing device 121 includes a series combination of resistors R10 and R11 which is connected between the output terminals of the buffer amplifiers 113 and 114. The junction between the resistors R10 and R11 is connected to the input terminal of the mid-frequency-range correction filter 117. The output terminal of the mid-frequency-range correction filter 117 is connected to the non-inverting input terminal of the mixer 118 via the switch 117A and a resistor R18. In addition, the output terminal of the mid-frequency-range correction filter 117 is connected to the non-inverting input terminal of the mixer 119 via the switch 117A and a resistor R15.

The subtracter 122 includes an operational amplifier. The non-inverting input terminal of the subtracter 122 is connected via a resistor R12 to the output terminal of the buffer amplifier 113. The inverting input terminal of the subtracter 122 is connected via a resistor R13 to the output terminal of the buffer amplifier 114. The subtracter 122 is successively followed by the CR filter 103 and the phase delay devices 115 and 116. The CR filter 103 has a resistor R14 and a capacitor C6. A first end of the resistor R14 is connected to the output terminal of the subtracter 122. A second end of the resistor R14 is connected to the input terminal of the phase delay device 115. The second end of the resistor R14 is grounded via the capacitor C6. The phase delay device 115 has a junction which is grounded via a capacitor C4. The output terminal of the phase delay device 115 is connected to the input terminal of the phase delay device 116. The phase delay device 116 has a junction which is grounded via a capacitor C5. The output terminal of the phase delay device 116 leads to the non-inverting input terminal of the mixer 118 via the switch 116A and a resistor R16. In addition, the output terminal of the phase delay device 116 leads to the non-inverting input terminal of the mixer 119 via the switch 116A and a resistor R17.

The third left-channel audio signal L is inputted into the mixer 118 from the buffer amplifier 113. The second right-channel audio signal R is inputted into the mixer 119 from the buffer amplifier 114.

The summing device 121 receives the third left-channel and right-channel audio signals L and R from the buffer amplifiers 113 and 114. The summing device 121 adds the third left-channel and right-channel audio signals L and R to generate a sum audio signal L+R. The mid-frequency-range correction filter 117 receives the sum audio signal L+R from the summing device 121, and corrects mid-frequency components thereof. The mid-frequency components mean components in a predetermined mid-frequency range. The mid-frequency-range correction filter 117 feeds the correction-resultant audio signal to the mixers 118 and 119 when the switch 117A is closed. The feed of the correction-resultant audio signal to the mixers 118 and 119 is blocked when the switch 117A is opened. Accordingly, the mid-frequency-range correction filter 117 is enabled and disabled when the switch 117A is closed and opened respectively. Preferably, the switch 117A can be controlled by a user or a listener.

The subtracter 122 receives the third left-channel and right-channel audio signals L and R from the buffer amplifiers 113 and 114. The device 122 subtracts the third right-channel audio signal R from the third left-channel audio signal L to generate a subtraction audio signal L−R. The device 122 may subtract the third left-channel audio signal L from the third right-channel audio signal R to generate a subtraction audio signal R−L. The subtracter 122 outputs the subtraction audio signal L−R to the CR filter 103. The CR filter 103 removes components from the subtraction audio signal L−R which are in a predetermined frequency range equal to the frequency range for which the correction by the sections 101a and 101b of the phase delay circuit 101 is implemented. The CR filter 103 outputs a resultant audio signal, that is, a filtered subtraction audio signal, to the phase delay device 115. The filtered subtraction audio signal is passed successively through the phase delay devices 115 and 116 while being delayed. Provided that the switch 116A is closed, the delayed subtraction audio signal propagates from the phase delay device 116 to the mixers 118 and 119. When the switch 116A is opened, the propagation of the delayed subtraction audio signal to the mixers 118 and 119 is blocked. Accordingly, the combination of the subtracter 122, the CR filter 103, and the phase delay devices 115 and 116 is enabled and disabled when the switch 116A is closed and opened respectively. Preferably, the switch 116A can be controlled by the user or the listener.

The mixer 118 combines the third left-channel audio signal L, the correction-resultant audio signal, and the delayed subtraction audio signal to form a left-channel surround audio signal Lo. The mixer 118 outputs the left-channel surround audio signal Lo. The mixer 119 combines the third right-channel audio signal R, the correction-resultant audio signal, and the delayed subtraction audio signal to form a right-channel surround audio signal Ro. The mixer 119 outputs the right-channel surround audio signal Ro. Then, the left-channel and right-channel surround audio signals Lo and Ro are transmitted to the external device via the apparatus output terminals 120D and 120E respectively.

The left-channel and right-channel surround audio signals Lo and Ro are expressed as follows.
Lo={GL+ΔtG(R−L)+KG(L+R)}
Ro={GR+ΔtG(L−R)+KG(L+R)}
where G denotes the transfer function of the phase delay circuit 101 and K denotes a mid-frequency-range correction coefficient in the mid-frequency-range correction filter 117, and At denotes the phase delay quantity given by the phase delay devices 115 and 116.

As previously mentioned, each of the transistors Q1 and Q2 in the phase delay circuit 101 is changed between the conductive state and the nonconductive state in accordance with the logic state of the control signal applied to the base thereof. When the transistors Q1 and Q2 are in the conductive states, the phase delay circuit 101 implements the correction of the first left-channel and right-channel audio signals LIN and RIN for expanding a sound image upward. On the other hand, the transistors Q1 and Q2 are in the nonconductive states, the phase delay circuit 101 merely serves as a buffer amplifier and does not implement the correction of the first left-channel and right-channel audio signals LIN and RIN. Accordingly, the sound-image upward expanding process by the phase delay circuit 101 is enabled and disabled in accordance with the logic state of the control signal applied to the bases of the transistors Q1 and Q2. Preferably, the logic state of the control signal can be selected by the user or the listener.

As previously mentioned, the phase delay circuit 101 subjects high-frequency components of the first left-channel and right-channel audio signals LIN and RIN to the correction including the phase shift and the amplitude emphasis. The correction increases the pressures of high-frequency reproduced sounds in areas in upper front (or upper left or right front) of the left-channel and right-channel loudspeakers, and hence results in upward expansions of sound images perceived by the listener and corresponding to the left-channel and right-channel loudspeakers. The signal processing by the surround circuit 108 increases the distance between virtual left-channel and right-channel sound sources perceived by the listener and corresponding to the left-channel and right-channel loudspeakers. As a result, an enhanced performance of stereophony is available. The phase shift by the phase delay circuit 101 improves the qualities of high-frequency sounds reproduced by the left-channel and right-channel loudspeakers.

The amplitude-frequency characteristic and the phase-frequency characteristic of the apparatus of FIG. 4 were measured. In addition, the amplitude-frequency characteristic and the phase-frequency characteristic of the prior-art surround circuit of FIG. 1 were measured for a comparison purpose. FIG. 5 shows the measurement results. In FIG. 5, A1 denotes the amplitude-frequency characteristic of the apparatus of FIG. 4 and B1 denotes that of the prior-art surround circuit of FIG. 1, and A2 denotes the phase-frequency characteristic of the apparatus of FIG. 4 and B2 denotes that of the prior-art surround circuit of FIG. 1.

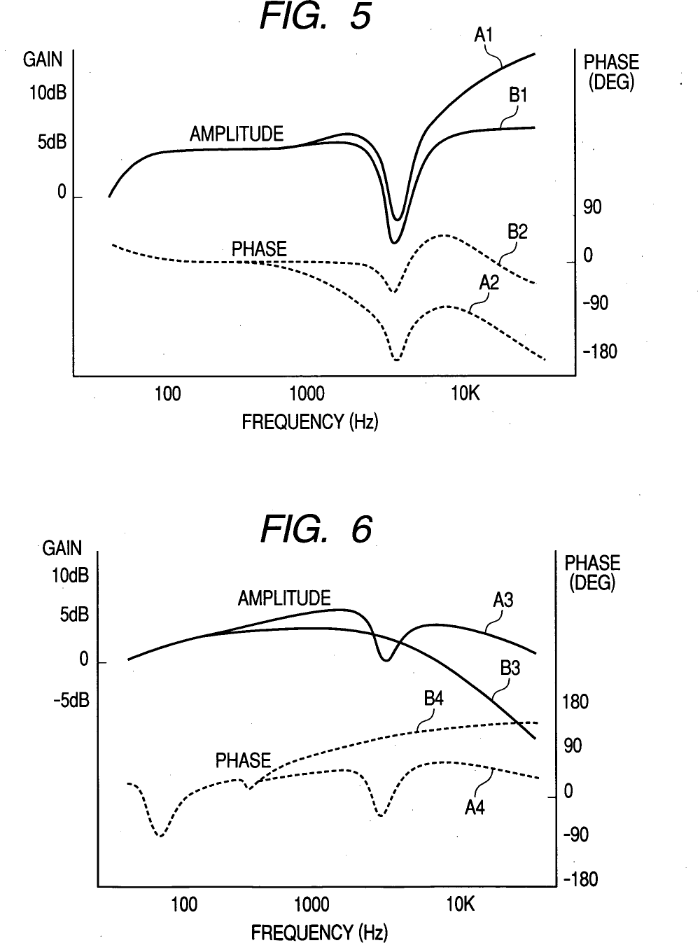

Sound reproduced by one selected from the left-channel and right-channel loudspeakers was measured in the following conditions. A test sound reproducing system was formed by successively connecting the apparatus of FIG. 4, a power amplifier, and left-channel and right-channel loudspeakers in respective boxes. A test audio signal was inputted to the test sound reproducing system from a test audio signal source. A sampling microphone and a measuring instrument were connected. The sampling microphone was on the upward inclined direction from the selected loudspeaker which formed an elevation angle of 45° with the axis of the selected loudspeaker. The distance between the selected loudspeaker and the sampling microphone was about 1 m. The selected loudspeaker reproduced sound represented by the test audio signal. A portion of the reproduced sound propagated from the selected loudspeaker to the sampling microphone. The sampling microphone converted the applied sound into a corresponding audio signal. The audio signal generated by the sampling microphone was measured by the measuring instrument to detect the amplitude-frequency characteristic and the phase-frequency characteristic of the test sound reproducing system while the test audio signal remained inputted to the test sound reproducing system. During the measurement, the apparatus of FIG. 4 was switched between an effective state where the correction of the test audio signal was implemented and an ineffective state (an initial state) where the correction of the test audio signal was not implemented. FIG. 6 shows the measurement results. In FIG. 6, A3 denotes the amplitude-frequency characteristic of the test sound reproducing system in which the apparatus of FIG. 4 was in the effective state, and B3 denotes that detected when the apparatus of FIG. 4 was in the initial state. In addition, A4 denotes the phase-frequency characteristic of the test sound reproducing system in which the apparatus of FIG. 4 was in the effective state, and B4 denotes that detected when the apparatus of FIG. 4 was in the initial state. It was revealed that the pressure of reproduced sound in a high-frequency range was boosted by the effective operation of the apparatus of FIG. 4, and the phase-frequency characteristic in a high-frequency range was flattened by the effective operation of the apparatus of FIG. 4.

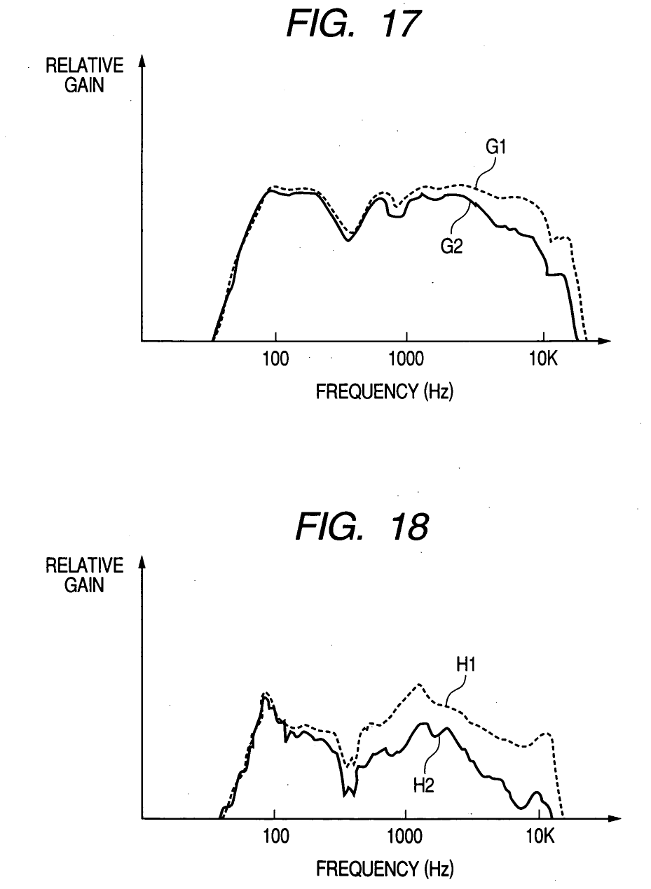

Further measurements were carried out. Sound reproduced by right-channel one among actual left-channel and right-channel loudspeakers was measured in the following conditions. A test sound reproducing system was formed by successively connecting the apparatus of FIG. 4, a power amplifier, and left-channel and right-channel loudspeakers in respective boxes. The values of the resistors R4, R5, and R6 in the apparatus of FIG. 4 were 10 kΩ, 4.7 kΩ, and 10 kΩ respectively, and the value of the capacitor C2 therein was 0.0068 μF. The values of the resistors R7, R8, and R9 in the apparatus of FIG. 4 were 10 kΩ, 4.7 kΩ, and 10 kΩ respectively, and the value of the capacitor C3 therein was 0.0068 μF. A test audio signal was inputted to the test sound reproducing system from a test audio signal source. A sampling microphone and a measuring instrument were connected. The sampling microphone was on the upward inclined direction from the left-channel loudspeaker which formed an elevation angle of 45° with the axis of the left-channel loudspeaker, and which formed an azimuth angle of 0° therewith. The distance between the left-channel loudspeaker and the sampling microphone was about 1 m. The left-channel loudspeaker reproduced sound represented by the test audio signal. A portion of the reproduced sound propagated from the left-channel loudspeaker to the sampling microphone. The sampling microphone converted the applied sound into a corresponding audio signal. The audio signal generated by the sampling microphone was measured by the measuring instrument to detect the amplitude-frequency characteristic and the phase-frequency characteristic of the test sound reproducing system while the test audio signal remained inputted to the test sound reproducing system. During the measurement, the apparatus of FIG. 4 was switched between an effective state where the correction of the test audio signal was implemented and an ineffective state (an initial state) where the correction of the test audio signal was not implemented. FIG. 17 shows the measurement results. In FIG. 17, G1 denotes the amplitude-frequency characteristic of the test sound reproducing system in which the apparatus of FIG. 4 was in the effective state, and G2 denotes that detected when the apparatus of FIG. 4 was in the initial state. It was revealed that the pressure of reproduced sound in mid-frequency and high-frequency ranges was boosted by the effective operation of the apparatus of FIG. 4, and hence a flat frequency response over a wide frequency range was obtained.

In addition, sound reproduced by right-channel one among actual left-channel and right-channel loudspeakers was measured in the following conditions. A test sound reproducing system was formed by successively connecting the apparatus of FIG. 4, a power amplifier, and left-channel and right-channel loudspeakers in respective boxes. The values of the resistors R4, R5, and R6 in the apparatus of FIG. 4 were 10 kΩ, 4.7 kΩ, and 10 kΩ respectively, and the value of the capacitor C2 therein was 0.0068 μF. The values of the resistors R7, R8, and R9 in the apparatus of FIG. 4 were 10 kΩ, 4.7 kΩ, and 10 kΩ respectively, and the value of the capacitor C3 therein was 0.0068 μF. A test audio signal was inputted to the test sound reproducing system from a test audio signal source. A sampling microphone and a measuring instrument were connected. The sampling microphone was on the upward and leftward inclined direction from the left-channel loudspeaker which formed an elevation angle of 45° with the axis of the left-channel loudspeaker, and which formed an azimuth angle of 45° therewith. The distance between the left-channel loudspeaker and the sampling microphone was about 1 m. The left-channel loudspeaker reproduced sound represented by the test audio signal. A portion of the reproduced sound propagated from the left-channel loudspeaker to the sampling microphone. The sampling microphone converted the applied sound into a corresponding audio signal. The audio signal generated by the sampling microphone was measured by the measuring instrument to detect the amplitude-frequency characteristic and the phase-frequency characteristic of the test sound reproducing system while the test audio signal remained inputted to the test sound reproducing system. During the measurement, the apparatus of FIG. 4 was switched between the effective state and the ineffective state (the initial state). FIG. 18 shows the measurement results. In FIG. 18, H1 denotes the amplitude-frequency characteristic of the test sound reproducing system in which the apparatus of FIG. 4 was in the effective state, and H2 denotes that detected when the apparatus of FIG. 4 was in the initial state. It was revealed that the pressure of reproduced sound in mid-frequency and high-frequency ranges was properly boosted by the effective operation of the apparatus of FIG. 4.

The apparatus of FIG. 4 has the following advantages. The apparatus of FIG. 4 is relatively simple in structure. The apparatus of FIG. 4 can expand a sound image upward. The apparatus of FIG. 4 provides a good quality of reproduced sound perceived by a listener even when listener's ears are substantially in upper front of the loudspeakers or in upper left or right front thereof.

The characteristics of the sound-image upward expansion provided by the apparatus of FIG. 4 can easily be changed by adjusting the circuit element parameters in the phase delay circuit 101. Thus, the apparatus of FIG. 4 has a high adaptability.

In the case where the apparatus of FIG. 4 is used in a sound reproducing system such as a CD/MD radio-cassette player/recorder which includes a loudspeaker unit or units usually placed on a floor, it is possible to remarkably improve the quality of reproduced sound perceived by a listener.

### Second Embodiment

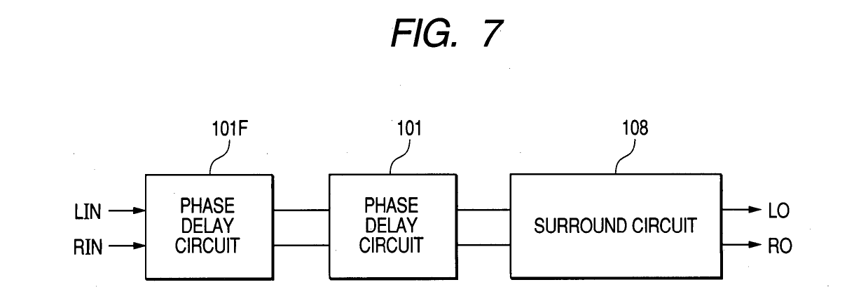

FIG. 7 shows a sound-image upward expanding apparatus according to a second embodiment of this invention. The apparatus of FIG. 7 is similar to the apparatus of FIG. 4 except that another phase delay circuit 101F is connected between the audio signal source and the phase delay circuit 101. Thus, the phase delay circuits 101 and 101F are connected in cascade. The structure of the phase delay circuit 101F is the same as that of the phase delay circuit 101. The cascade combination of the phase delay circuits 101 and 101 F provides a phase delay of 0° to −360° and a greater high-frequency signal component boost, and further expands a sound image upward.

### Third Embodiment

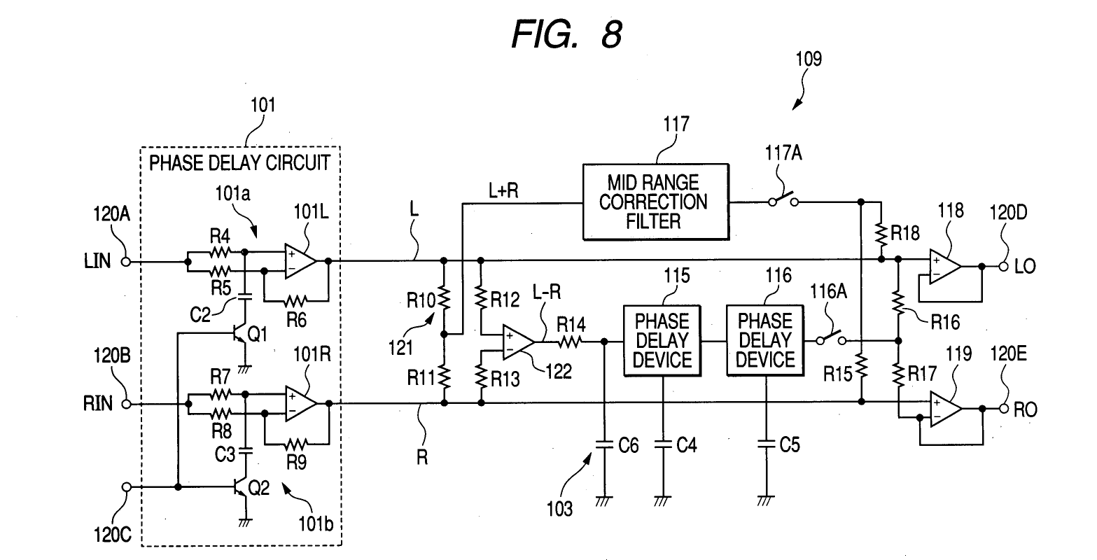

FIG. 8 shows a sound-image upward expanding apparatus according to a third embodiment of this invention. The apparatus of FIG. 8 is similar to the apparatus of FIG. 4 except that a surround circuit 109 replaces the surround circuit 108 (see FIG. 4). The surround circuit 109 is formed by omitting the buffer amplifiers 113 and 114 from the surround circuit 108. As shown in FIG. 8, the output terminal of the operational amplifier 101L in the phase delay circuit 101 is followed by a mixer 118, a summing device 121, and a subtracter 122 in the surround circuit 109. The output terminal of the operational amplifier 101 R in the phase delay circuit 101 is followed by a mixer 119, the summing device 121, and the subtracter 122 in the surround circuit 109.

1. An apparatus for expanding a sound image upward, comprising:
a left-channel phase delay circuit for correcting phases and amplitudes of components of an input left-channel audio signal which are in a predetermined high-frequency range to generate a corrected left-channel audio signal;
a right-channel phase delay circuit for correcting phases and amplitudes of components of an input right-channel audio signal which are in the predetermined high-frequency range to generate a corrected right-channel audio signal; and
a surround circuit for generating left-channel and right-channel surround audio signals in response to the corrected left-channel and right-channel audio signals generated by the left-channel phase delay circuit and the right-channel phase delay circuit;
wherein the surround circuit includes a summing circuit for adding the corrected left-channel and right-channel audio signals to generate an addition signal, a mid-frequency-range correction filter for filtering the addition signal to generate a filtered signal, a subtracter for subtracting one of the corrected left-channel and right-channel audio signals from the other to generate a first difference signal, a filter circuit for removing components from the first difference signal which are in the predetermined high-frequency range to generate a second difference signal, a phase delay device for delaying a phase of the second difference signal to generate a third difference signal, a first mixer for combining the corrected left-channel audio signal, the filtered signal, and the third difference signal to generate the left-channel surround audio signal, and a second mixer for combining the corrected right-channel audio signal, the filtered signal, and the third difference signal to generate the right-channel surround signal.

2. An apparatus as recited in claim 1, wherein the left-channel phase delay circuit includes:
a first resistor;
a second resistor;
an operational amplifier having a first input terminal receiving the input left-channel audio signal via the first resistor, a second input terminal receiving the input left-channel audio signal via the second resistor, and an output terminal followed by the surround circuit;
a third resistor connected between the second input terminal and the output terminal of the operational amplifier; and
a capacitor having a first end connected to a junction between the first resistor and the first input terminal of the operational amplifier and a second end grounded.

3. An apparatus as recited in claim 2, wherein values of the first and third resistors are substantially equal, and a value of the second resistor is smaller than each of the values of the first and third resistors.

4. An apparatus as recited in claim 2, further comprising a switch interposed between the capacitor and a ground.

5. An apparatus as recited in claim 1, wherein the right-channel phase delay circuit includes:
a first resistor;
a second resistor;
an operational amplifier having a first input terminal receiving the input right-channel audio signal via the first resistor, a second input terminal receiving the input right-channel audio signal via the second resistor, and an output terminal followed by the surround circuit;
a third resistor connected between the second input terminal and the output terminal of the operational amplifier; and
a capacitor having a first end connected to a junction between the first resistor and the first input terminal of the operational amplifier and a second end grounded.

6. An apparatus as recited in claim 5, wherein values of the first and third resistors are substantially equal, and a value of the second resistor is smaller than each of the values of the first and third resistors.

7. An apparatus as recited in claim 5, further comprising a switch interposed between the capacitor and a ground.

8. An apparatus for expanding a sound image upward, comprising:
a first left-channel phase delay circuit for correcting phases and amplitudes of components of an input left-channel audio signal which are in a predetermined high-frequency range to generate a first corrected left-channel audio signal;
a second left-channel phase delay circuit for correcting phases and amplitudes of components of the first corrected left-channel audio signal which are in the predetermined high-frequency range to generate a second corrected left-channel audio signal;
a first right-channel phase delay circuit for correcting phases and amplitudes of components of an input right-channel audio signal which are in the predetermined high-frequency range to generate a first corrected right-channel audio signal;
a second right-channel phase delay circuit for correcting phases and amplitudes of components of the first corrected right-channel audio signal which are in the predetermined high-frequency range to generate a second corrected right-channel audio signal; and
a surround circuit for generating left-channel and right-channel surround audio signals in response to the second corrected left-channel and right-channel audio signals generated by the second left-channel phase delay circuit and the second right-channel phase delay circuit;
wherein the surround circuit includes a summing circuit for adding the second corrected left-channel and right-channel audio signals to generate an addition signal, a mid-frequency-range correction filter of filtering the addition signal to generate a filtered signal, a subtracter for subtracting one of the second corrected left-channel and right-channel audio signals from the other to generate a first difference signal, a filter circuit for removing components from the first difference signal which are in the predetermined high-frequency range to generate a second difference signal, a phase delay device for delaying a phase of the second difference signal to generate a third difference signal, a first mixer for combining the second corrected left-channel audio signal, the filtered signal, and the third difference signal to generate the left-channel surround audio signal, and a second mixer for combining the second corrected right-channel audio signal, the filtered signal, and the third difference signal to generate the right-channel surround signal.

9. An apparatus for expanding a sound image upward, comprising:
a first resistor;
a second resistor;
an operational amplifier having a first input terminal receiving an input audio signal via the first resistor, a second input terminal receiving the input audio signal via the second resistor, and an output terminal;
a third resistor connected between the second input terminal and the output terminal of the operational amplifier;
a capacitor having a first end connected to a junction between the first resistor and the first input terminal of the operational amplifier and a second end grounded; and
a surround circuit connected to the output terminal of the operational amplifier.

10. An apparatus as recited in claim 9, wherein values of the first and third resistors are substantially equal, and a value of the second resistor is smaller than each of the values of the first and third resistors.

11. An apparatus as recited in claim 9, further comprising a switch interposed between the capacitor and a ground.
